(19) United States
(12) Patent Application Publication
(10) Pub. No.: US 2026/0053259 A1
(43) Pub. Date: Feb. 26, 2026

(54) Smart Phone Holster Case Device

(71) Applicant: Herbert Dunbar, Gretna, LA (US)

(72) Inventor: Herbert Dunbar, Gretna, LA (US)

(21) Appl. No.: 19/310,420

(22) Filed: Aug. 26, 2025

Related U.S. Application Data
(60) Provisional application No. 63/686,934, filed on Aug. 26, 2024.

(51) Int. Cl. A45F 5/00; A45C 11/00; A45C 13/10; A45F 5/02; H04M 1/02; H04M 1/04

(52) U.S. Cl. CPC A45F 5/1516; A45C 11/002; A45F 5/021; H04M 1/0281; H04M 1/04; A45C 2013/1015

(57) ABSTRACT

A smart phone holster case device is disclosed, which is a mobile phone cover and holster for the purpose of securing and providing protection for the smart phone. The smart phone holster case device comprises a body component that is configured to retain a Z fold smart phone or other suitable smart phone. The body component is comprised of black, hand-stitched leather. The body component has the appearance of a holster with a cover flap secured by hook and loop fasteners. The body component includes a swivel clip on the back that is adjustable and allows both vertical and horizontal rotation, such that users can be either right-handed or left-handed.

### CROSS-REFERENCE TO RELATED APPLICATION

The present application claims priority to, and the benefit of, U.S. Provisional Application No. 63/686,934, which was filed on Aug. 26, 2024, and is incorporated herein by reference in its entirety.

### FIELD OF THE INVENTION

The present invention relates generally to the field of smart phone holster case devices. More specifically, the present invention relates to a phone holster to protect and secure a smart phone. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in smart phone holster case devices. Generally, people may lack proper cases for their mobile phones depending on the make or model of phone. Further, more obscure or less common models may not have enough choices for cases compared to mainline phone models.

However, dropping a phone can lead to significant damage and require expensive repairs. Typically, having a smart phone requires a phone case to protect the phone from any damage or drops. Further, a holster phone case can make it easy to transport and utilize the smart phone for hands-free calls, etc.

Accordingly, there is a demand for an improved smart phone holster case device that acts to protect and secure a smart phone. More particularly, there is a demand for a smart phone holster case device that contains a closeable flap cover for extra protection and security.

Therefore, there exists a long felt need in the art for a smart phone holster case device that provides users with a phone holster to protect and secure a Z fold phone. There is also a long felt need in the art for a smart phone holster case device that features a swivel clip for left or right-hand usability and convenience. Further, there is a long felt need in the art for a smart phone holster case device that prevents damage to the phone or screen if accidentally dropped. Moreover, there is a long felt need in the art for a device that contains a closeable flap cover for extra protection and security for the phone not being lost or stolen. Further, there is a long felt need in the art for a smart phone holster case device that comprises a black, hand-stitched leather case. Finally, there is a long felt need in the art for a smart phone holster case device that secures the flap with hook and loop fasteners for additional security.

The subject matter disclosed and claimed herein, in one embodiment thereof, comprises a smart phone holster case device. The device is a mobile phone cover and holster for the purpose of securing and providing protection for the smart phone. The smart phone holster case device comprises a body component that is configured to retain a Z fold smart phone or other suitable smart phone. The body component is comprised of black, hand-stitched leather. The body component has the appearance of a holster with a cover flap secured by hook and loop fasteners. The body component includes a swivel clip on the back that is adjustable and allows both vertical and horizontal rotation, such that users can be either right-handed or left-handed.

In this manner, the smart phone holster case device of the present invention accomplishes all of the forgoing objectives and provides users with a device that protects and secures a smart phone. The device is a leather holster case. The device comprises a swivel clip to allow rotation of the device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart phone holster case device. The smart phone holster case device comprises a body component that is configured to retain a Z fold smart phone or other suitable smart phone. The body component has the appearance of a holster with a cover flap secured by hook and loop fasteners. The body component includes a swivel clip on the back that is adjustable and allows both vertical and horizontal rotation.

In one embodiment, the smart phone holster case device acts to protect and secure a Z fold smart phone or other suitable smart phone as is known in the art. The device prevents damage to the smart phone or screen if accidentally dropped. Further, the smart phone holster case device is a smart phone cover and holster for the purpose of securing and providing protection for the smart phone.

In one embodiment, the smart phone holster case device comprises a body component, which is sized and shaped to receive a smart phone. Specifically, a Z fold smart phone, but can be any suitable smart phone as is known in the art. The body component comprises a front wall, a back wall, two side walls, and a bottom surface, which all form an open cavity for accepting the smart phone therein. Specifically, the open cavity in between the front wall, the back wall, the two side walls, and the bottom surface, is preferably formed in a size adapted for insertion of the Z fold smart phone. Preferably, the entire front and rear surface of the Z fold smart phone, once inserted within the open cavity, is protected.

In one embodiment, the open cavity is preferably lined with a soft and compressible material such as felt or foam, etc., for protection of the smart phone while within the cavity.

In one embodiment, the body component is manufactured of black, hand-stitched leather, but can be any suitable color or material as is known in the art, depending on the needs and/or wants of a user. For example, the body component can be manufactured of vinyl, nylon, polyester, vegan leather, etc., or any other durable material as is known in the art.

In one embodiment, the body component has the appearance of a holster with a cover flap that encloses the open cavity. The flap is sized and shaped to be attached to a top of the back wall and then wrapped over the open cavity and secured to the top of the front wall, to completely enclose the cavity and secure the smart phone within the cavity. In one embodiment, the cover flap is secured to the front wall via any suitable fasteners as is known in the art, such as hook and loop fasteners, snaps, a button, an adhesive, etc.

In one embodiment, the exterior of the back wall of the body component comprises a belt clip, which is sized and shaped to secure the device to a user's belt, pocket, waistband, or pants, or any other suitable place on a user as is known in the art. In one embodiment, the belt clip is spring-loaded to securely anchor the device in place on the user. In use, the belt clip is squeezed open to accept fabric or a belt and then released to secure and retain the body component and smart phone in place. In one embodiment, the belt clip has a security latch, which when locked prevents the body component from being accidentally or maliciously removed from the user.

In one embodiment, the body component includes a swivel component on the back wall that is adjustable and allows both vertical and horizontal rotation, such that users can be either right-handed or left-handed during use. Thus, the body component is secured to the user via the belt clip and then can be rotated via the swivel component in either a vertical or horizontal direction. Typically, the swivel component is a pin connection to allow rotation, but can be any suitable rotating means as is known in the art. Once in position, the swivel component can be locked in place or the swivel component can ratchet horizontally and vertically. This provides an ergonomic position for either a right-handed or left-handed user. Thus, the swivel component allows the body component to be comfortably used by both left-handed and right-handed users.

In one embodiment, the body component includes an RF blocking layer. The RF blocking layer is included to inhibit or block RF radiation from reaching the body of the user. Typically, the RF blocking layer is positioned on the back wall, the two side walls, and the bottom surface. Preferably, all or at least a portion of the front wall may remain unscreened to allow the smart phone to communicate with the cellular system unimpeded. Typically, the RF blocking layer is formed of metal foil or material which will absorb and block RF energy, such as lead foil or aluminum foil material.

In yet another embodiment, the smart phone holster case device comprises a plurality of indicia.

In yet another embodiment, a method of securing a Z fold smart device is disclosed. The method includes the steps of providing a smart phone holster case device comprising a body component with a cover flap secured by hook and loop fasteners. The method also comprises securing the device to a user's belt via a belt clip. Further, the method comprises inserting a Z fold smart device or other suitable smart phone into the body component. The method also comprises securing the cover flap over the body component to secure the smart phone within the device. Finally, the method comprises utilizing the swivel component to rotate the device vertically or horizontally, as desired.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one embodiment of the smart phone holster case device of the present invention showing the blank view of the case device in accordance with the disclosed architecture;

FIG. 2 illustrates a front view of one embodiment of the smart phone holster case device of the present invention showing the formed view of the front of the case device in accordance with the disclosed architecture;

FIG. 3 illustrates a back view of one embodiment of the smart phone holster case device of the present invention showing the formed view of the back and side of the case device in accordance with the disclosed architecture;

FIG. 4 illustrates a perspective view of one embodiment of the smart phone holster case device of the present invention showing the body component and flap open in accordance with the disclosed architecture;

FIG. 5 illustrates a side perspective view of one embodiment of the smart phone holster case device of the present invention showing the belt clip and swivel component of the body component in accordance with the disclosed architecture; and

FIG. 6 illustrates a flowchart showing the method of securing a Z fold smart device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a smart phone holster case device that provides users with a phone holster to protect and secure a Z fold phone. There is also a long felt need in the art for a smart phone holster case device that features a swivel clip for left or right-hand usability and convenience. Further, there is a long felt need in the art for a smart phone holster case device that prevents damage to the phone or screen if accidentally dropped. Moreover, there is a long felt need in the art for a device that contains a closeable flap cover for extra protection and security for the phone not being lost or stolen. Further, there is a long felt need in the art for a smart phone holster case device that comprises a black, hand-stitched leather case. Finally, there is a long felt need in the art for a smart phone holster case device that secures the flap with hook and loop fasteners for additional security.

The present invention, in one exemplary embodiment, is a novel smart phone holster case device. The smart phone holster case device comprises a body component that is configured to retain a Z fold smart phone or other suitable smart phone. The body component has the appearance of a holster with a cover flap secured by hook and loop fasteners. The body component includes a swivel clip on the back that is adjustable and allows both vertical and horizontal rotation, such that users can be either right-handed or left-handed. The present invention also includes a novel method of securing a Z fold smart device. The method includes the steps of providing a smart phone holster case device comprising a body component with a cover flap secured by hook and loop fasteners. The method also comprises securing the device to a user's belt via a belt clip. Further, the method comprises inserting a Z fold smart device or other suitable smart phone into the body component. The method also comprises securing the cover flap over the body component to secure the smart phone within the device. Finally, the method comprises utilizing the swivel component to rotate the device vertically or horizontally, as desired.

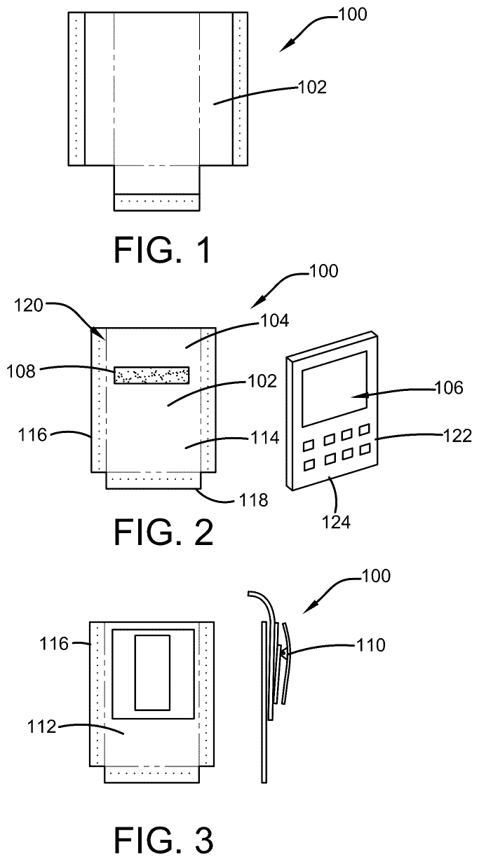

Referring initially to the drawings, FIGS. 1-3 illustrate a perspective view of one embodiment of the smart phone holster case device 100 of the present invention. In the present embodiment, the smart phone holster case device 100 is an improved smart phone holster case device 100 that provides a user with a phone holster for securing a smart phone 106. Specifically, the smart phone holster case device 100 comprises a body component 102 with a cover flap 104. The body component 102 has the appearance of a holster with a cover flap 104 secured by hook and loop fasteners 108. The body component 102 includes a swivel clip 110 on the back wall 112 that is adjustable and allows both vertical and horizontal rotation.

Generally, the smart phone holster case device 100 acts to protect and secure a Z fold smart phone 106 or other suitable smart phone as is known in the art. The device 100 prevents damage to the smart phone 106 or screen if accidentally dropped. Further, the smart phone holster case device 100 is a smart phone cover and holster for the purpose of securing and providing protection for the smart phone 106.

Further, the smart phone holster case device 100 comprises a body component 102, which is sized and shaped to receive a smart phone 106. Specifically, a Z fold smart phone 106, but can be any suitable smart phone 106 as is known in the art. The body component 102 comprises a front wall 114, a back wall 112, two side walls 116, and a bottom surface 118, which all form an open cavity 120 for accepting the smart phone 106 therein. Specifically, the open cavity 120 in between the front wall 114, the back wall 112, the two side walls 116, and the bottom surface 118, is preferably formed in a size adapted for insertion of the Z fold smart phone 106. Preferably, the entire front 122 and rear surface 124 of the Z fold smart phone 106, once inserted within the open cavity 120, is protected.

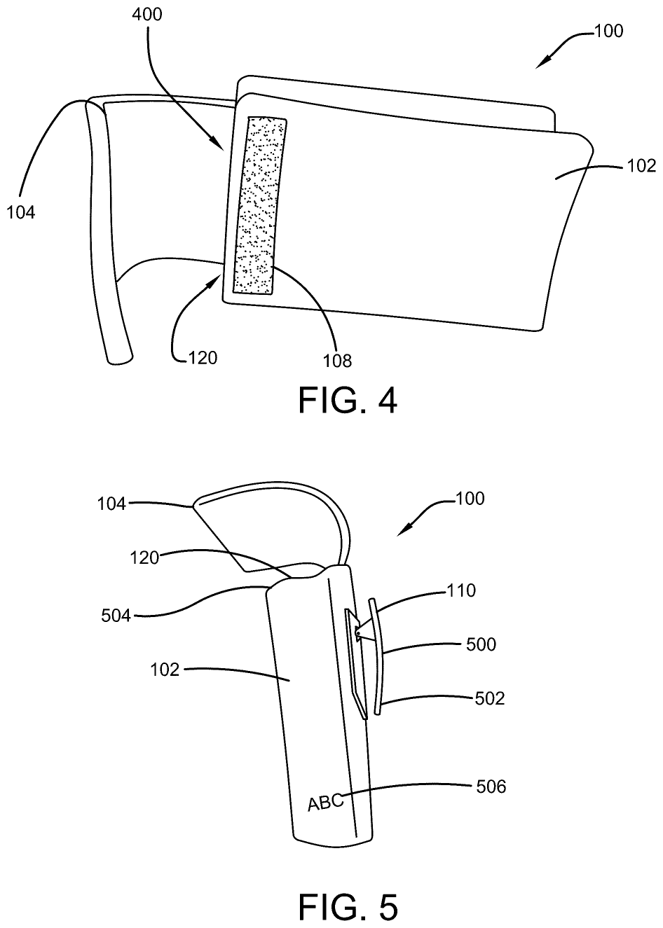

As shown in FIG. 4, the body component 102 has the appearance of a holster with a cover flap 104 that encloses the open cavity 120. The flap 104 is sized and shaped to be attached to a top of the back wall 112 and then wrapped over the open cavity 120 and secured to the top of the front wall 114, to completely enclose the cavity 120 and secure the smart phone 106 within the cavity 120. In one embodiment, the cover flap 104 is secured to the front wall 114 via any suitable fasteners as is known in the art, such as hook and loop fasteners 108, snaps, a button, an adhesive, etc.

Further, the body component 102 is manufactured of black, hand-stitched leather, but can be any suitable color or material as is known in the art, depending on the needs and/or wants of a user. For example, the body component 102 can be manufactured of vinyl, nylon, polyester, vegan leather, etc., or any other durable material as is known in the art.

Additionally, in one embodiment, the open cavity 120 is preferably lined with a soft and compressible material 400 such as felt or foam, etc., for protection of the smart phone 106 while within the cavity 120.

As shown in FIG. 5, the exterior of the back wall 112 of the body component 102 comprises a belt clip 500, which is sized and shaped to secure the device 100 to a user's belt, pocket, waistband, or pants, or any other suitable place on a user as is known in the art. In one embodiment, the belt clip 500 is spring-loaded to securely anchor the device 100 in place on the user. In use, the belt clip 500 is squeezed open to accept fabric or a belt and then released to secure and retain the body component 102 and smart phone 106 in place. In one embodiment, the belt clip 500 has a security latch 502, which when locked prevents the body component 102 from being accidentally or maliciously removed from the user.

Further, the body component 102 includes a swivel component 110 on the back wall 112 that is adjustable and allows both vertical and horizontal rotation, such that users can be either right-handed or left-handed during use. Thus, the body component 102 is secured to the user via the belt clip 500 and then can be rotated via the swivel component 110 in either a vertical or horizontal direction. Typically, the swivel component 110 is a pin connection to allow rotation, but can be any suitable rotating means as is known in the art. Once in position, the swivel component 110 can be locked in place or the swivel component 110 can ratchet horizontally and vertically. This provides an ergonomic position for either a right-handed or left-handed user. Thus, the swivel component 110 allows the body component 102 to be comfortably used by both left-handed and right-handed users.

In one embodiment, the body component 102 includes an RF blocking layer 504. The RF blocking layer 504 is included to inhibit or block RF radiation from reaching the body of the user. Typically, the RF blocking layer 504 is positioned on the back wall 112, the two side walls 116, and the bottom surface 118. Preferably, all or at least a portion of the front wall 114 may remain unscreened to allow the smart phone 106 to communicate with the cellular system unimpeded. Typically, the RF blocking layer 504 is formed of metal foil or material which will absorb and block RF energy, such as lead foil or aluminum foil material.

In yet another embodiment, the smart phone holster case device 100 comprises a plurality of indicia 506. The body component 102 of the device 100 may include advertising, a trademark, or other letters, designs, or characters, printed, painted, stamped, or integrated into the body component 102, or any other indicia 506 as is known in the art. Specifically, any suitable indicia 506 as is known in the art can be included, such as but not limited to, patterns, logos, emblems, images, symbols, designs, letters, words, characters, animals, advertisements, brands, etc., that may or may not be cell phone, case protector, or brand related.

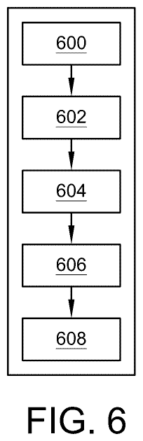

FIG. 6 illustrates a flowchart of the method of securing a Z fold smart device. The method includes the steps of at 600, providing a smart phone holster case device comprising a body component with a cover flap secured by hook and loop fasteners. The method also comprises at 602, securing the device to a user's belt via a belt clip. Further, the method comprises at 604, inserting a Z fold smart device or other suitable smart phone into the body component. The method also comprises at 606, securing the cover flap over the body component to secure the smart phone within the device. Finally, the method comprises ay 608, utilizing the swivel component to rotate the device vertically or horizontally, as desired.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “smart phone holster case device”, “smart phone device”, “holster case device”, and “device” are interchangeable and refer to the smart phone holster case device 100 of the present invention.

Notwithstanding the forgoing, the smart phone holster case device 100 of the present invention can be of any suitable size and configuration as is known in the art without affecting the overall concept of the invention, provided that it accomplishes the above stated objectives. One of ordinary skill in the art will appreciate that the smart phone holster case device 100 as shown in FIGS. 1-6 is for illustrative purposes only, and that many other sizes and shapes of the smart phone holster case device 100 are well within the scope of the present disclosure. Although the dimensions of the smart phone holster case device 100 are important design parameters for user convenience, the smart phone holster case device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart phone holster case device that provides a user with a phone holster for securing a smart phone, the smart phone holster case device comprising:
a body component; and
a cover flap;
wherein the body component is sized and shaped to retain a smart phone;
wherein the body component has appearance of a holster with the cover flap; and
further wherein the cover flap is secured by hook and loop fasteners.

2. The smart phone holster case device of claim 1, wherein the smart phone is a Z fold smart phone, but can be any suitable smart phone as is known in the art.

3. The smart phone holster case device of claim 2, wherein the body component comprises a front wall, a back wall, two side walls, and a bottom surface, which all form an open cavity for accepting the smart phone therein.

4. The smart phone holster case device of claim 3, wherein the open cavity in between the front wall, the back wall, the two side walls, and the bottom surface, is preferably formed in a size adapted for insertion of the Z fold smart phone.

5. The smart phone holster case device of claim 4, wherein an entire front and rear surface of the Z fold smart phone, once inserted within the open cavity, is protected.

6. The smart phone holster case device of claim 5, wherein the cover flap encloses the open cavity.

7. The smart phone holster case device of claim 6, wherein the cover flap is sized and shaped to be attached to a top of the back wall and then wrapped over the open cavity and secured to a top of the front wall, to completely enclose the open cavity and secure the Z fold smart phone within the open cavity.

8. The smart phone holster case device of claim 7, wherein the body component is manufactured of black, hand-stitched leather.

9. The smart phone holster case device of claim 8, wherein an exterior of the back wall of the body component comprises a belt clip, which secures the smart phone holster case device to a user's belt, pocket, waistband, or pants.

10. The smart phone holster case device of claim 9, wherein the belt clip is spring-loaded to securely anchor the smart phone holster case device in place on a user.

11. The smart phone holster case device of claim 10, wherein in use, the belt clip is squeezed open to accept fabric or a belt and then released to secure and retain the body component and Z fold smart phone in place.

12. The smart phone holster case device of claim 11, wherein the body component includes a swivel component on the back wall that is adjustable and allows both vertical and horizontal rotation, such that users can be either right-handed or left-handed during use.

13. The smart phone holster case device of claim 12, wherein the body component is secured to the user via the belt clip and then can be rotated via the swivel component in either a vertical or horizontal direction.

14. A smart phone holster case device that provides a user with a phone holster for securing a smart phone, the smart phone holster case device comprising:
a body component comprises a front wall, a back wall, two side walls, and a bottom surface, which all form an open cavity for accepting a smart phone therein; and
a cover flap encloses the open cavity, which is secured by hook and loop fasteners;
wherein the body component is sized and shaped to retain a Z fold smart phone;
wherein the body component has appearance of a holster with the cover flap;
wherein the cover flap is secured by hook and loop fasteners;
wherein the body component is manufactured of black, hand-stitched leather;
wherein an exterior of the back wall of the body component comprises a belt clip, which secures the smart phone holster case device to a user's belt, pocket, waistband, or pants;
wherein the belt clip is spring-loaded to securely anchor the smart phone holster case device in place on a user;
wherein in use, the belt clip is squeezed open to accept fabric or a belt and then released to secure and retain the body component and Z fold smart phone in place; and
further wherein the body component includes a swivel component on the back wall that is adjustable and allows both vertical and horizontal rotation, such that users can be either right-handed or left-handed during use.

15. The smart phone holster case device of claim 14, wherein the swivel component includes a pin connection to allow rotation, once in position, the swivel component can be locked in place or the swivel component can ratchet horizontally and vertically.

16. The smart phone holster case device of claim 14, wherein the body component includes an RF blocking layer.

17. The smart phone holster case device of claim 14, wherein the open cavity is preferably lined with a soft and compressible material, such as felt or foam, for protection of the Z fold smart phone while within the open cavity.

18. The smart phone holster case device of claim 14, wherein the belt clip has a security latch, which when locked prevents the body component from being accidentally or maliciously removed from the user.

19. The smart phone holster case device of claim 14 further comprising a plurality of indicia.

20. A method of securing a Z fold smart phone, the method comprising the following steps:
providing a smart phone holster case device comprising a body component with a cover flap secured by hook and loop fasteners;
securing the device to a user's belt via a belt clip;
inserting a Z fold smart phone or other suitable smart phone into the body component;
securing the cover flap over the body component to secure the smart phone within the device; and
utilizing the swivel component to rotate the device vertically or horizontally, as desired.
